(19) United States
(12) Patent Application Publication
(10) Pub. No.: US 2006/0135092 A1
(43) Pub. Date: Jun. 22, 2006

(54) Radio frequency filter

(75) Inventor: Ingo Mayr, Niederndorf (AT)

Correspondence Address: NIXON & VANDERHYE, PC, 901 NORTH GLEBE ROAD, 11TH FLOOR, ARLINGTON, VA, 22203, US

(73) Assignee: Kathrein Austria Ges. m. b. H., Kufstein (AT)

(21) Appl. No.: 11/012,718

(22) Filed: Dec. 16, 2004

(51) Int. Cl. H04B 1/04

(52) U.S. Cl. 455/125; 455/123

(57) ABSTRACT

The invention relates to a coaxial radio frequency filter, having one or more resonators, with at least one of the resonators having the following features:
an inner conductor which is in the form of an inner conductor tube (2) and is composed of at least one first material;
an outer conductor housing (1) having a housing base (1a), a housing wall (1b) and a cover (3) which extends from the housing wall (1b) and can be positioned on the housing upper face, with the inner conductor tube (2) being electrically coupled to the housing base (1a), and a free end (2a) of the inner conductor tube (2) being located adjacent to the housing upper face and/or to the cover (3);
a compensation element (6) composed of at least one second material, which is connected to the inner conductor tube (2);
wherein the at least one second material of the compensation element (6) acts on the at least one first material of at least one subsection of the inner conductor tube (2) by exerting mechanical force, such that the thermal expansion of the at least one first material and/or the length of the inner conductor tube (2) are/is influenced.

The invention relates to a coaxial radio frequency filter and to a corresponding method for tuning and production of a radio frequency filter such as this.

In radio systems, particularly in the mobile radio field, a common antenna is frequently used for transmission and received signals. In this case, the transmission or received signals each use different frequency ranges, and the antenna must be suitable for transmission and reception in both frequency ranges. A suitable frequency filter is therefore required in order to separate the transmission and received signals, by means of which on the one hand the transmission signals are passed on from the transmitter to the antenna, and on the other hand the received signals are passed on from the antenna to the receiver. Nowadays, inter alia, coaxial radio frequency filters are used to split the transmission and received signals.

Coaxial radio frequency filters have coaxial resonators in which resonator cavities are formed in an outer conductor housing, in which inner conductors in the form of inner conductor tubes are arranged. The inner conductor tubes each have a free end which is located adjacent to a cover that is arranged on the upper face of the housing. Temperature fluctuations lead to a change in the mechanical length of the inner conductor tube. Since the mechanical length is inversely proportional to the frequency, the resonant frequency of the filter falls when the mechanical length increases as the temperature rises. This dominant effect leads, for example in the case of a filter with a resonant frequency of 1 GHz, to a change in the resonant frequency of 1 MHz for a temperature difference of 40° C. Temperature changes result in a further, second effect. A capacitance is formed between the cover and the inner conductor tube (the so-called head capacitance) at the free end of the inner conductor. This capacitance also governs the frequency. When a temperature increase occurs, the inner conductor tube expands, and the walls of the outer conductor housing expand by the same factor. Since the walls of the outer conductor housing are higher than the inner conductor tube, this leads to an increase in the distance between the inner conductor tube and the cover, which results in a decrease in the head capacitance and leads to an increase in the resonant frequency. This effect thus counteracts the reduction in the resonant frequency resulting from the greater mechanical length of the inner conductor tube when temperature increases occur. However, the effect is very minor and is not significant.

In order to increase the effect of the reduction in the head capacitance when temperature increases occur, it is known from the prior art for parts of the inner conductor tube or else the entire inner conductor to be manufactured from a different material with a lower thermal coefficient of expansion than that of the outer conductor housing. Thus, when the temperature rises, the head capacitance becomes even smaller and compensates for the effect of the frequency increase resulting from the temperature-dependent length expansion. Filters such as these allow temperature compensation to be achieved by the resonators in the filter having a constant resonant frequency within a specific temperature range. However, this type of compensation has a number of disadvantages. Since the inner conductor or parts of the inner conductor are composed of a different material to the housing, a disturbance point always occurs between two materials, even when the two are soldered to one another. Apart from manufacturing problems, this can also lead to intermodulation problems. Furthermore, a number of different materials must be joined together in the resonator area, which is critical to the radio frequency, in which case mechanical tolerances in this area may have serious influences on the filter. If, for example, an inner conductor is not positioned in the filter with an accuracy of a few hundredths of a millimeter, the coupling bandwidth for all the adjacent resonators changes, and this can once again result in tuning problems. Furthermore, the optimization in the development phase of the filter takes a large amount of time, since a specific compensation element must be developed for virtually each inner conductor. Furthermore, large-scale production involves a large number of different parts which must be joined together, thus making the assembly process more difficult. In particular, confusion can occur during the assembly process, and special tools must be used during assembly. This also increases the price of the filter.

The document U.S. Pat. No. 6,407,651 B1 discloses a radio frequency filter of this generic type, in which a compensation element is used which is fitted to the inner conductor tube and is connected via a bellows to the upper face of the inner conductor tube. The position of the compensation element can be varied by means of an adjusting screw. Temperature compensation can be provided for the filter by the use of different materials for the compensation element and for the screw.

The object of the invention is to provide a coaxial radio frequency filter which can be manufactured more easily than filters which are known from the prior art and whose radio frequency characteristics can be varied in a simple manner.

This object is achieved by the independent patent claims. Developments of the invention are defined in the dependent claims.

In the radio frequency filter according to the invention, the inner conductor tube is composed of at least one first material, and the compensation element is composed of at least one second material. The expression inner conductor tube should in this case be understood in general form, and covers all types of elements in the form of posts with an internal cavity. In particular, the cross section of the inner conductor tube may have any desired shape, for example a quadrilateral, a hexagonal or a cylindrical shape, or the like. The materials are connected in such a way that the at least one second material acts mechanically on the at least one first material of at least one subsection of the inner conductor tube in such a way that the thermal expansion of the first material and/or the length of the inner conductor tube are/is influenced. This means that characteristics of the second material influence the first material as a result of a mechanical connection between the first and second material. In particular, the thermal coefficient of expansion of the second material may be “forced onto” the first material. If the thermal coefficient of expansion of the second material is chosen to be lower than that of the first, temperature compensation can be carried out in this way. Furthermore, the length of the inner conductor tube can be influenced by the compensation element exerting mechanical force on the inner conductor tube. In the radio frequency filter according to the invention, there is preferably no need to manufacture the inner conductor tube separately from a different material to that of the housing. The production of the filter is thus simplified, since no mechanical tolerances occur when joining different materials together, and no special tools are required for assembly. Furthermore, intermodulation problems are avoided since there are no disturbance points at junction points between different materials. Furthermore, it is easy to influence the mechanical force which the second material exerts on the first material, so that the filter can be optimized considerably more quickly and easily.

The compensation element is preferably arranged underneath the free end of the inner conductor tube, so that the material of the compensation element itself does not significantly directly influence the head capacitance. Furthermore, the compensation element can be detachably connected to the inner conductor tube, so that the compensation element can be replaced by another, depending on the purpose.

In one particularly preferred variant, the compensation element exerts a force essentially in the direction of the housing base on the at least one subsection of the inner conductor tube, thus making it possible to influence, in a simple manner, the thermal expansion of the first material and to reduce the length of the inner conductor tube by means of the downward force. In a further variant, the at least one subsection of the inner conductor tube is a section of the inner conductor tube of smaller thickness. The first material of the inner conductor tube thus opposes the second material of the compensation element with less force, thus increasing the temperature compensation achieved by the compensation element.

In a further preferred variant, the at least one second material of the compensation element is a material with a higher tensile strength than the at least one first material of the inner conductor tube. The tensile strength of the at least one second material is preferably at least 100%, preferably at least 150%, and particularly preferably at least 200% greater than the tensile strength of the at least one first material. Furthermore, the thermal coefficient of expansion of the first material may be higher than that of the second material, to be precise in particular by at least 50%, preferably by at least 100%, and particularly preferably by at least 130%. By way of example, the inner conductor tube may be manufactured from aluminum, and the compensation element may be composed of steel and/or ceramic.

In one particularly preferred variant of the invention, the compensation element is essentially held in the interior of the inner conductor tube, and is mechanically connected to an inner surface section of the inner conductor tube. The inner surface section may in this case rest on the lower end, in the central area or on the upper end of the inner conductor tube. This makes it possible to vary the size of the subsection on which the second material of the compensation element acts. The higher the inner surface section is positioned in the inner conductor tube, the greater is the compensation for the length expansion of the material, provided that the compensation element exerts a force in the direction of the housing base. The housing base of the outer conductor housing is preferably provided on its lower face with an opening to the interior of the inner conductor tube, via which the compensation element is accessible in a simple manner.

In a further preferred variant, the force with which the at least one second material of the compensation element acts on the at least one first material of the inner conductor tube is variable. In one particularly preferred variant of the invention, this is achieved by means of a compensation element which is formed by a screw that is positioned in the interior of the inner conductor tube and is screwed into at least one threaded section formed in the interior of the inner conductor tube. The at least one threaded section can be positioned as required in the interior of the inner conductor tube, and in particular it may be located in the lower part, in the central part or in the upper part of the inner conductor tube, thus influencing the intensity of the compensation. In one preferred variant, a screwdriving tool can be positioned at one end of the screw in order to turn the screw, with this end being arranged at the opening on the lower face of the housing base. The tensile force exerted by the screw on the inner conductor tube can thus be influenced, and the filter tuned, in a simple manner, from the outside.

In a further particularly preferred refinement of the invention, the screw has an internal cavity. Furthermore, at least one tuning element is preferably provided, which is arranged at or adjacent to the free end of the inner conductor tube and is composed of metallic and/or dielectric material. The tuning element may, for example, be arranged in a cover that is positioned on the housing upper face of the outer conductor housing, although it is also possible for the tuning element to be positioned at least partially in the inner conductor tube. In the latter case, the tuning element is preferably at least partially held in the internal cavity in the screw, with the internal cavity for this purpose having, in particular, an internal threaded section at its end adjacent to the free end of the inner conductor tube, for the tuning element to be screwed into.

The outer conductor housing is preferably formed integrally with the inner conductor tube, for example as a milled part or casting, so that no intermodulation problems occur as a result of joints in the filter. The filter according to the invention may, for example, be in the form of a duplexer, a bandpass filter or a bandstop filter.

In addition to the filter described above, the invention also covers a tuning method for a filter such as this, in which case the mechanical force which the at least one second material of the compensation element exerts on the at least one first material of the inner conductor tube is used to tune the electrical radio frequency characteristics of the radio frequency filter.

The invention furthermore relates to a method for production of the radio frequency filter according to the invention. In this method, an outer conductor housing with a housing base and a housing wall is produced, with at least one inner conductor tube composed of at least one first material being formed or arranged in the interior of the outer conductor housing. At least one compensation element composed of at least one second material is then connected to the inner conductor tube and, finally, the electrical radio frequency characteristics of the filter are tuned by appropriately setting the mechanical force which the at least one second material of the compensation element exerts on the at least one first material of the inner conductor tube. During the production process, the at least one inner conductor tube is preferably formed integrally with the outer conductor housing, thus greatly simplifying the manufacture of the filter.

Exemplary embodiments of the invention will be described in detail in the following text with reference to the attached figures, in which:

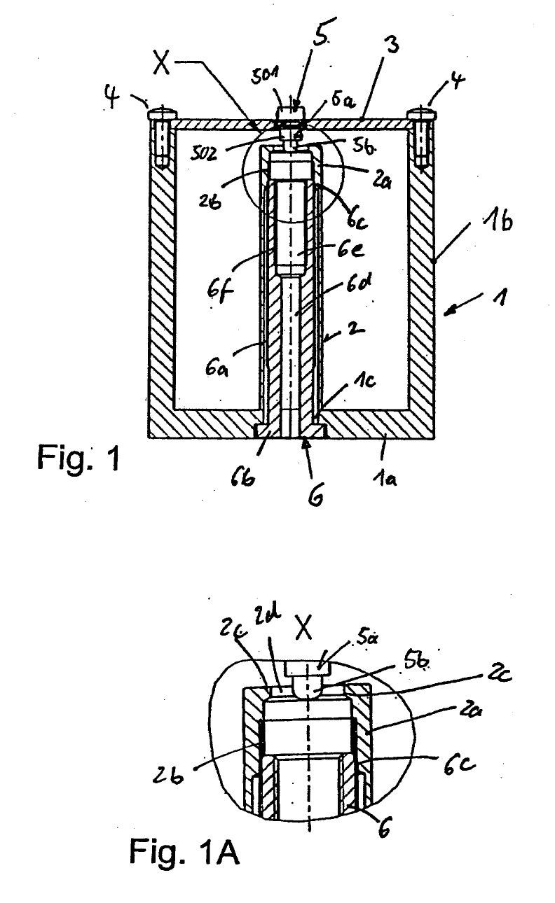

FIG. 1 shows a sectioned side view of a resonator for a first embodiment of the radio frequency filter according to the invention;

FIG. 1A shows a detailed view of the detail X from FIG. 1;

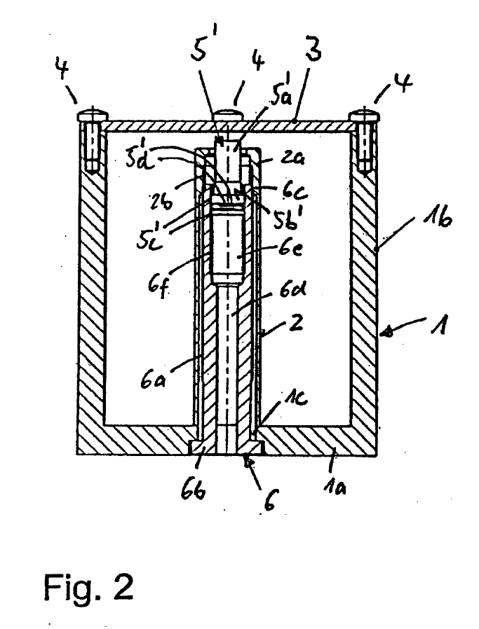

FIG. 2 shows a sectioned side view of a resonator for a second embodiment of the radio frequency filter according to the invention;

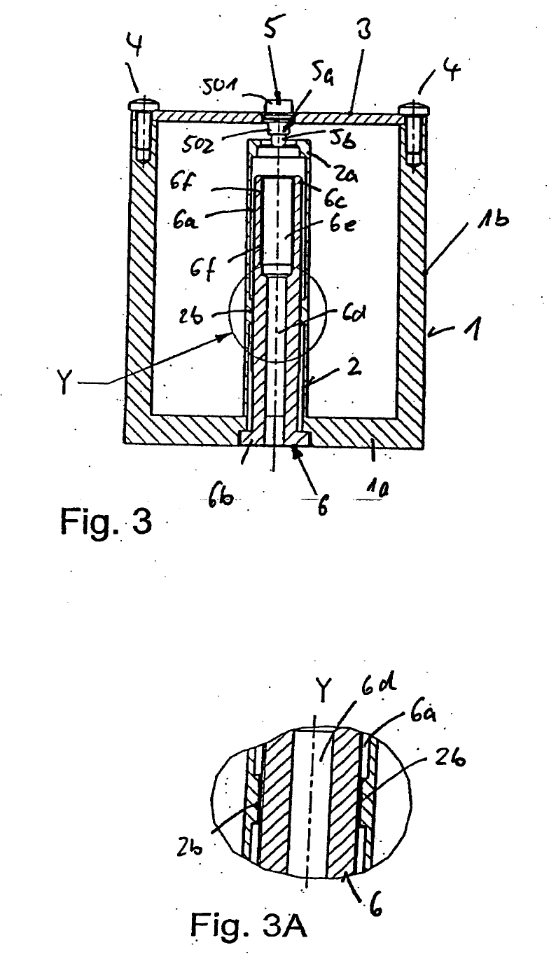

FIG. 3 shows a sectioned side view of a resonator for a third embodiment of the radio frequency filter according to the invention;

FIG. 3A shows a detailed view of the detail Y from FIG. 3;

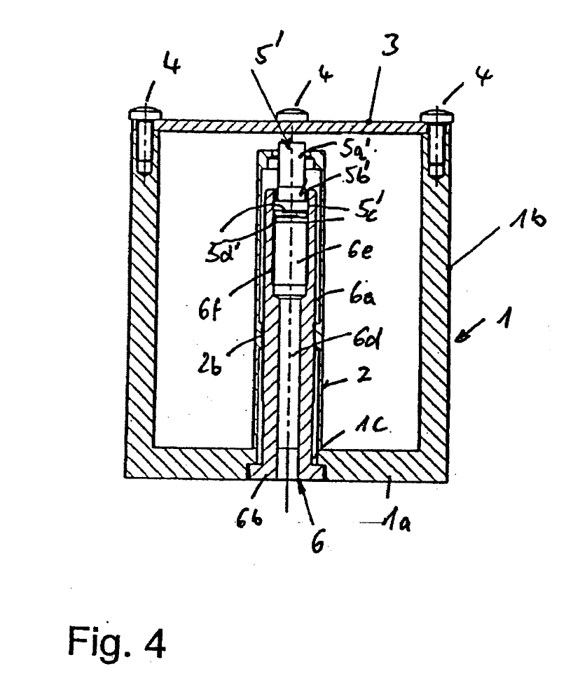

FIG. 4 shows a sectioned side view of a resonator for a fourth embodiment of the radio frequency filter according to the invention.

FIG. 1 shows a sectioned side view of a resonator which is used in a first embodiment of the radio frequency filter according to the invention. The radio frequency filter itself may comprise a large number of such resonators. The resonator shown in FIG. 1 has an outer conductor housing 1 with a housing base 1a, from which a circumferential housing wall 1b extends. Coupling openings for electrical coupling to adjacent resonators can be provided in the housing wall, and the housings of all the resonators may be formed integrally from one material. An inner conductor in the form of a cylindrical inner conductor tube 2 is formed integrally in the housing base 1a, with the inner conductor tube being arranged centrally within the cavity that is formed by the housing wall 1b. A cover 3 is screwed on the upper face of the outer conductor 1 by means of a number of screws 4. It is also feasible for the cover not to be attached to the housing upper face, but for the edge of the cover to surround an upper part of the housing wall and to be connected to a lower part of the housing wall in an area between the housing upper face and the housing base. If required, the cover may also surround the entire housing wall and may be connected to the outer conductor housing on the housing base. A tuning element 5 (which is in the form of a push-in socket 5a and is pushed into the cover 3) is located in the center of the cover and has an upper section 501 above the cover, as well as a lower section 502 below the cover. An internal thread is provided in the push-in socket, into which a tuning stub 5b is screwed, which projects from the lower end of the push-in socket 5a. The tuning stub has a hexagonal holder (not shown) at its upper end, which is located in the push-in socket, so that the distance between the tuning stub and the upper, free end 2a of the inner conductor tube 2 can be varied by means of an appropriate hexagonal key. This distance change also influences the capacitance between the inner conductor tube and the cover, thus making it possible to influence the resonant frequency of the resonator, and thus to tune the radio frequency filter. The push-in socket and the tuning stub may both be composed, for example, of brass.

A compensation element in the form of a compensation screw 6 is provided in the interior of the inner conductor tube and has an external thread 6a (which is indicated by a thickened edge) and a screw head 6b. The screw has been inserted into the inner conductor tube 2 through an opening 1c in the base of the housing 1 via the lower face of the base, and is screwed to the inner conductor tube 2 at the free end 2a. The inner conductor tube for this purpose has a thickened section at the end 2a, on which an internal thread 2b is provided, as indicated by the thick lines. The internal thread 2b and the external thread 6a fit into one another, so that the screw 6 can be screwed into the inner conductor tube 2. For this purpose, one or more slots or a hexagonal slot is or are provided on the screw head 6b, for the insertion of a screwdriving tool for turning the compensation screw. In FIG. 1, the length of the screw 6 has been chosen such that only a small front section 6c of the external thread 6a engages in the lower end of the internal thread 2b. However, it is also possible for the screw to be longer and to be screwed further into the internal thread 2b.

The screw 6 is hollow internally and has a lower cylindrical cavity 6d (which extends upwards from the screw head 6b and has a small diameter) to which a cavity 6e with a larger diameter is connected, and extends as far as the upper tip 6c of the screw 6. An internal thread 6f (indicated by a thicker black line) is provided in the upper cavity 6e, into which a further tuning element can be screwed, as will be described in more detail further below.

The screw 6 is preferably composed of a different material, for example of a different metal or a ceramic, to the outer conductor housing 1 and the inner conductor tube which is formed integrally in this housing. The screw 6 is preferably made of a material which has a greater tensile strength and a lower thermal coefficient of expansion than the inner conductor tube. In particular, the tensile strength of the material of the screw is greater by at least 100%, preferably by at least 150% and particularly preferably by at least 200%, than the tensile strength of the material of the inner conductor tube. The thermal coefficient of expansion of the inner conductor tube is preferably higher by at least 50%, in particular by at least 100%, and particularly preferably by at least 130% than the thermal coefficient of expansion of the screw. For example, the screw 6 may be composed of steel, while in contrast the inner conductor tube 2 is composed of aluminum. Aluminum of the EN AW-5083 type may be used as the material for the inner conductor tube, which has a yield strength R_{p0.2} of at least 105 N/mm² and a tensile strength Rₘ of at least 255 N/mm². The thermal coefficient of expansion of this material is 24.2×10⁻⁶/K. By way of example, stainless steel of the X17CrNi 16-2 type may be used as the material for the screw. This stainless steel has a yield strength R_{p0.2} of at least 600 N/mm² and a tensile strength Rₘ of at least 800 N/mm². The thermal coefficient of expansion of this material is 10.0×10⁻⁶/K. The materials mentioned above result in a difference in the length expansion of 0.027 mm for a clamped-in length of 48 mm and a temperature difference of 40° C.

The screw 6 is screwed into the upper thread 2b in the inner conductor tube with a torque so as to exert a tensile force on the inner conductor tube in the direction of the housing base which is sufficiently high that the thermal coefficient of expansion of the material of the screw is “forced onto” the thermal coefficient of expansion of the material of the inner conductor tube. Thermal expansion of the material of the inner conductor tube which exceeds the thermal expansion of the screw is thus prevented by the compensation screw 6, since the inner conductor is “kept short” in the elastic range as the temperature rises, by virtue of the tensile force from the screw.

In conventional resonators, the resonant frequency is reduced as the temperature rises, owing to the increase in the mechanical length of the inner conductor tube. In the exemplary embodiment shown in FIG. 1, this effect is counteracted by the thermal expansion being reduced by the lower thermal coefficient of expansion of the screw, with the distance between the cover 3 and the free end 2a of the inner conductor tube at the same time being increased, which leads to a decrease in the capacitance between the cover and the inner conductor tube. This results in a reduction of the resonant frequency, so that the filter as shown in FIG. 1 compensates for temperature-dependent fluctuations in the resonant frequency, in a simple manner. Furthermore, this allows simple tuning of the filter by variation of the tensile stress on the screw, that is to say by turning the screw 6 in the internal thread 2b. Specifically, owing to the greater tensile strength of the material of the compensation screw 6, an increase in the tensile stress leads to slight shortening of the mechanical length of the inner conductor tube 2, which in turn influences the resonant frequency. The resonant frequency can thus be tuned in a suitable manner simply by turning the compensation screw 6. The compensation intensity in the filter shown in FIG. 1 can also be influenced by varying the wall thickness of the inner conductor tube. The thinner the wall of the inner conductor tube, the smaller is the force of the inner conductor tube which counteracts the tensile force of the screw when thermal expansion occurs. In consequence, the compensation is greater for thin inner conductor tubes than for thick inner conductor tubes.

FIG. 1A shows a detailed view of the detail X, as shown in FIG. 1, at the upper free end 2a of the inner conductor tube 2. This shows the thickened section of the inner conductor tube 2 at the free end 2a in detail, with this thickened section having a cylindrically circumferential shoulder 2c at the upper end, thus forming an opening 2d in which the tuning stub 5b engages. Once again, this also shows in detail that only the foremost tip 6c of the screw 6 engages in the internal thread 2b in the inner conductor tube 2.

FIG. 2 shows a sectioned side view of a resonator for a second embodiment of the radio frequency filter according to the invention. The design of the resonator shown in FIG. 2 corresponds very largely to that of the resonator shown in FIG. 1. The only difference is that a tuning element 5′, which is screwed into the internal thread 6f in the compensation screw 6, is used instead of the tuning element 5 in the cover 3. The tuning element 5′ has a socket 5b′ which, at its lower end, has two external threaded sections 5c′, which are separated from one another by two incisions 5d′ (indicated by thickened lines). The socket 5b′ is slightly compressed in the area of the incisions 5d′. This results in a clamping effect of the external threaded sections 5c′ which are screwed into the internal thread 6f, so that the position of the tuning element in the screw does not vary when vibration occurs. The actual tuning part 5a′ is located in the socket 5b′ and, in the embodiment shown in FIG. 2, is composed of dielectric and preferably ceramic material, and is pushed into the socket 5b′. The tuning part extends from the socket 5b′ upwards through the upper opening in the free end 2a of the inner conductor tube 2, and likewise influences the resonant frequency of the resonator. The tuning can be carried out by varying the position of the tuning element 5′ in the internal thread 6f in the screw 6.

FIG. 3 shows a sectioned side view of a resonator for a third embodiment of the radio frequency filter according to the invention. The design of the filter shown in FIG. 3 is similar to that of the filter shown in FIG. 1, in particular using the same tuning element 5 located in the cover 3. The compensation screw 6 in FIG. 3 also corresponds to the compensation screw 6 shown in FIG. 1. The major difference between the filter shown in FIG. 3 and that shown in FIG. 1 is that the thickened section of the inner conductor tube with the internal thread 2b is no longer arranged at the upper, free end 2a of the inner conductor tube 2, but in the central-region of the inner conductor tube.

In this case, FIG. 3A shows a more detailed illustration of the detail Y, showing the thickened section in the central region of the inner conductor tube 2. Analogously to the embodiment shown in FIG. 1, the compensation screw 6 has an external thread 6a which is screwed into the internal thread 2b in such a way as to force the thermal coefficient of expansion of the screw onto the inner conductor tube. In contrast to FIG. 1, the thermal expansion compensation which is produced in this way does not, however, act over the entire length of the inner conductor tube, but only on the lower section of the inner conductor tube, which extends from the thickened section of the internal thread 2b to the upper face of the housing base 1a. In the area above the thread 2b, the inner conductor tube 2 expands in accordance with its own thermal coefficient of expansion. Since the thermal coefficient of expansion of the material of the inner conductor tube is preferably greater than the coefficient of the compensation screw, the overall length of the inner conductor tube expands more in the embodiment shown in FIG. 3 when temperature increases occur, so that the resonant frequency varies to a greater extent owing to the more greatly enlarged mechanical length of the resonator and the less greatly enlarged distance between the cover 3 and the free end 2a of the inner conductor tube. The intensity of the thermal compensation can thus be adapted in a simple manner by varying the section of the inner conductor tube on which the tensile force of the compensation screw acts. In this case, it is also possible for the threaded section 2b to be moved even further downwards to the foot point of the inner conductor tube, with the thermal compensation becoming ever less as the threaded section 2b is located ever more deeply. Analogously to FIG. 1, the length of the inner conductor tube 2 can also be varied by increasing the tightening torque on the screw 6, so that the filter can also be tuned by means of the compensation screw 6.

FIG. 4 shows a sectioned side view of a resonator for a fourth embodiment of the radio frequency filter according to the invention. The embodiment shown in FIG. 4 corresponds essentially to the embodiment shown in FIG. 3. In particular, the inner conductor tube and the compensation screw as well as the housing are identical to those in FIG. 3. However, in contrast to FIG. 3, a tuning element 5′ as has already been described in FIG. 2 is used. This tuning element is screwed into the internal thread 6f in the upper cavity 6e of the compensation screw 6. Since the components of the embodiment shown in FIG. 4 have already been described above with reference to FIG. 1 and FIG. 2, FIG. 4 will not be described in any more detail.

1. A coaxial radio frequency filter, having one or more resonators, with at least one of the resonators comprising:
an inner conductor which is in the form of an inner conductor tube and is composed of at least one first material;
an outer conductor housing having a housing base, a housing wall and a cover which extends from the housing wall and can be positioned on the housing upper face, with the inner conductor tube being electrically coupled to the housing base, and a free end of the inner conductor tube being located adjacent to the housing upper face and/or to the cover;
a compensation element composed of at least one second material, which is connected to the inner conductor tube;
wherein
the at least one second material of the compensation element acts on the at least one first material of at least one subsection of the inner conductor tube by exerting mechanical force, such that the thermal expansion of the at least one first material and/or the length of the inner conductor tube are/is influenced.

2. The radio frequency filter according to claim 1, wherein the compensation element is arranged essentially underneath the free end of the inner conductor tube and/or essentially within the inner conductor tube.

3. The radio frequency filter according to claim 1, wherein the compensation element detachably connected to the inner conductor tube.

4. The radio frequency according to claim 1, wherein the compensation element exerts a force essentially in the direction of the housing base on the at least one subsection of the inner conductor tube

5. The radio frequency filter according to claim 1, wherein the at least one subsection is a section of the inner conductor tube of reduced thickness.

6. The radio frequency filter according to claim 1, wherein the at least one second material of the compensation element has a higher tensile strength than the at least one first material of the inner conductor tube.

7. The radio frequency filter according to claim 6, wherein the tensile strength of the at least one second material is greater by at least 100%, preferably by at least 150%, and particularly preferably by at least 200% than the tensile strength of the at least one first material.

8. The radio frequency filter according to claim 1, wherein the at least one first material has a higher thermal coefficient of expansion than the at least one second material.

9. The radio frequency filter according to claim 8, wherein the thermal coefficient of expansion of the at least one first material is higher by at least 50%, preferably by at least 100%, particularly preferably by at least 130% than the thermal coefficient of expansion of the at least one second material.

10. The radio frequency filter according to one of the claim 1, wherein the at least one first material is aluminum, and/or the at least one second material includes steel and/or ceramic.

11. The radio frequency filter according to claim 1, wherein the compensation element is essentially arranged in the interior of the inner conductor tube and is mechanically to at least one section of the inner surface of the inner conductor tube.

12. The radio frequency filter according to claim 11, wherein the at least one section of the inner surface is positioned in the lower and/or central and/or upper part of the inner conductor tube.

13. The radio frequency filter according to claim 1, wherein the housing base has on its lower face an opening to the interior of the inner conductor tube, via which the compensation element is accessible.

14. The radio frequency filter according to claim 1, wherein the mechanical force which the at least one second material of compensation element exerts on the at least one first material of the inner conductor tube is variable.

15. The radio frequency filter according to claim 1, wherein the compensation element is a screw which is positioned in the interior of the inner conductor tube and is screwed into at least one threaded section that is formed in the interior of the inner conductor tube.

16. The radio frequency filter according to claim 15, wherein the at least one threaded section is positioned in the lower and/or central and/or upper part of the inner conductor tube.

17. The radio frequency filter according to claim 15, wherein a screwdriving tool can be positioned at one end of the screw in order to turn the screw, with this end being arranged at the opening on the lower face of the housing base.

18. The radio frequency filter according to claim 15, wherein the screw has an internal cavity.

19. The radio frequency filter according to claim 1, wherein at least one tuning element, which is arranged at or adjacent to the free end of the inner conductor tube, is provided and is composed of dielectric and/or conductive material.

20. The radio frequency filter according to claim 19, wherein the at least one tuning element is attached to the cover which is positioned on the housing upper face of the outer conductor housing.

21. The radio frequency filter according to claim 19, wherein the at least one tuning element is at least partially positioned in the inner conductor tube.

22. The radio frequency filter according to claim 21, wherein the tuning element is arranged at least partially in the internal cavity in the screw.

23. The radio frequency filter according to claim 22, wherein the internal cavity has an internal threaded section, for the tuning element to be screwed into, at its end adjacent to the free end of the inner conductor tube.

24. The radio frequency filter according to claim 1, wherein the outer conductor housing is formed integrally with the inner conductor tube, in particular as part or casting.

25. The radio frequency filter according to claim 1, wherein the resonators are designed and coupled so as to form a duplexor.

26. The radio frequency filter according to claim 1, wherein the resonators are designed and coupled so as to form a bandpass filter or a bandstop filter.

27. The method for tuning a radio frequency filter according to claim 1, wherein the mechanical force which the at least one second material of the compensation element exerts on the at least one first material of the inner conductor tube is used to tune the electrical radio frequency characteristics of the radio frequency filter.

28. A method for production of a radio frequency filter, comprising: producing an outer conductor housing with a housing base and a housing wall, with at least one inner conductor tube composed of at least one first material being formed or arranged in the interior of the housing;
connecting at least one compensation element composed of at least one second material to the inner conductor tube; and
tuning the electrical radio frequency characteristics of the radio frequency filter,
wherein the mechanical force which the at least one second material of the compensation element exerts on the at least one first material of the inner conductor tube is used to tune the electrical radio frequency characteristics of the radio frequency filter.

29. Method according to claim 28, wherein the at least one inner conductor tube is formed integrally with the outer conductor housing.
